(19) United States
(12) Patent Application Publication
(10) Pub. No.: US 2001/0040596 A1
(43) Pub. Date: Nov. 15, 2001

(54) Inkjet printhead with two-dimensional nozzle arrangement and method of fabricating the same

(75) Inventors: Jae Duk Lee, Paldal-gu (KR); Chul Hi Han, Yusong-gu (KR); Choon Sup Lee, Dong-gu (KR); Ki Chul Chun, Yongin-shi (KR)

Correspondence Address: FOLEY & LARDNER, Washington Harbour, 3000 K Street, N.W., Suite 500, P.O. Box 25696, Washington, DC, 20007-8696, US

(73) Assignee: Korea Advanced Institute of Science and Technology

(21) Appl. No.: 09/729,269

(22) Filed: Dec. 5, 2000

(30) Foreign Application Priority Data
May 3, 2000 (KR) 2000-23620

(51) Int. Cl. B41J 2/145; B41J 2/15; B23K 26/00

(52) U.S. Cl. 347/12; 347/5; 347/40; 219/121.71

(57) ABSTRACT

A high-speed, high-resolution inkjet printhead. At least two ink-supply paths used to supply ink to the ink chamber are arranged on the substrate in a two-dimensional array. The present invention overcomes the disadvantages of conventional inkjet printheads, i.e., low degree of integration arising from nozzles aligned in a line around a single ink-supply path. Thus, according to the present invention, a large number of nozzles can be integrated on the substrate, thus resulting in high-speed, high-resolution printing.

### BACKGROUND OF THE INVENTION

1. Field of the Invention

The present invention relates to a printhead and, more particularly, to an inkjet printhead capable of high-resolution, high-speed printing and a method of fabricating such printhead with a process employing the same degree of integration as in conventional processes.

2. Description of the Prior Art

Methods of ejecting ink in conventional inkjet printheads are classified into two types. The first type, as disclosed in U.S. Pat. No. 4,338,611 to Eida et al., is the side-shooter type in which nozzles are formed on the side face of a printhead substrate and ink is ejected in the side direction. The second type, as disclosed in U.S. Pat. No. 4,931,813 to Pan et al., is the roof-shooter type in which nozzles are formed on the top face of the printhead substrate and ink is ejected to the upper direction.

Among the above two types, the side-shooter type has a drawback that nozzles can only be arranged in a single line, because nozzles are arranged on the side face of the printhead substrate. Further, the roof-shooter type also has a drawback that nozzles can only be arranged in a single line or double lines, even though nozzles are arranged on the top face of the printhead substrate. This is because, as shown in FIG. 1., the main ink-supply path 15 used to supply ink to an ink chamber is formed as a single orifice on the silicon substrate 10, and the ink channels 14 and the nozzles 12 are arranged around the main ink-supply path 15. When the main ink-supply path 15 is formed in the center of the silicon substrate 10 and the nozzles 12 are arranged in a single line, as shown in FIG. 1, the distance between the printed lines cannot be less than 40 μm, if the technology used to form the printhead does not allow the distance (μ) between the nozzles 12 to be less than 40 μm.

As an improvement to the roof-shooter type, U.S. Pat. No. 5,648,806 to Steinfield et al. discloses simplifying the formation of the main ink-supply path by utilizing the side face of the substrate as the main ink-supply path. However, this still has a drawback that no more than two rows of nozzles can be formed on the side face of the substrate. Accordingly, the degree of integration in the arrangement of nozzles becomes lower and the number of nozzles integrated on the printhead becomes fewer, thus lowering the ink ejection speed. In order to double the resolution in high-resolution inkjet printheads while printing the same area in the same amount of time, the ink ejection speed needs to be four times faster than that of conventional printheads, because the size of the droplets of ink is small. Therefore, even if high-resolution nozzles are made with conventional arrangement of nozzles, slow printing speed always becomes a problem and thus high-resolution printing cannot be achieved practically.

In addition, U.S. Pat. No. 4,558,333 to Sugitani et al. discloses dividing an ink chamber to many small chambers in order to improve the degree of integration in the arrangement of nozzles. However, this arrangement still has only a single ink-supply path and the ink-supply speed is different for each ink chamber. Thus, it has a drawback that ink cannot be supplied fast and smoothly and that the fluid dynamics interference between ink chambers is very strong so that it is impractical for actual use.

### SUMMARY OF THE INVENTION

Therefore, it is an object of the present invention to provide an inkjet printhead capable of high-resolution, high-speed printing and a method of fabricating such inkjet printhead with a process having the same degree of integration as in conventional processes.

To this end, an inkjet printhead is provided, the inkjet printhead comprising a substrate having at least four ink-supply path orifices arranged in a two-dimensional array, nozzles connected to each of the ink-supply path orifices, driving means for driving the nozzles, and an electrical device for decoding an electric signal provided from outside the inkjet printhead and transmitting the decoded electric signal to the driving means in order to selectively drive the nozzles.

It is preferable that the two-dimensional array of the ink-supply orifices is an n×n array or a 1×n array, wherein n is a natural number greater than 1.

It is also possible to make the size of the nozzles different in each area of the two-dimensional array, thereby implementing a variety of resolutions and enhancing the printing speed.

The driving means ejects ink from the nozzles by heat ejection or piezoelectric ejection, and the electrical device is a switching device such as a diode or a metal-oxide-silicon (MOS) transistor and is preferably integrated on the substrate.

The nozzles are formed in the nozzle plate that covers the ink-supply path orifices, and it is preferable for the nozzle plate to include a conductive layer that can function as a power supply line or a ground line for driving the inkjet printhead.

It is also preferable that the two-dimensional array of ink-supply path orifices and nozzles comprises rows forming an angle with respect to a printing-movement direction of the printhead.

In order to achieve the above technical objects of the present invention, the method of fabricating an inkjet printhead of the present invention comprises monolithic processes consistent with a high-resolution printhead. That is, the method includes forming nozzles directly on a silicon substrate and forming at least two ink-supply paths in a two-dimensional array on the silicon substrate by an electro-chemical etching process or by deep reactive ion etching (DRIE).

### BRIEF DESCRIPTION OF THE DRAWINGS

FIG. 1 is a diagram illustrating the arrangement of nozzles in a conventional inkjet printhead;

FIG. 2 is a diagram illustrating the two-dimensional arrangement of ink-supply paths and nozzles in an inkjet printhead according to an embodiment of the present invention;

FIG. 3 is a perspective view of an inkjet printhead integrated on a silicon substrate according to an embodiment of the present invention.

FIG. 4 is a diagram illustrating the relation between the arrangement of nozzles and printing of the inkjet printhead according to an embodiment of the present invention;

FIGS. 5a and 5b are diagrams illustrating the arrangement of nozzles in order to enhance printing speed;

FIG. 6 is a diagram illustrating the arrangement of nozzle blocks and pads according to an embodiment of the present invention;

FIG. 7 is a layout diagram of a printhead according to an embodiment of the present invention;

FIGS. 8a through 8k are process cross-sectional views illustrating the method of fabricating an inkjet printhead according to a first embodiment of the present invention;

FIGS. 9a through 9c are process cross-sectional views illustrating the method of fabricating an inkjet printhead according to a second embodiment of the present invention;

FIGS. 10a through 10c are perspective views illustrating the use of a single photolithography process to form a three-dimensional nozzle mold to be used for plating; and

FIGS. 11 is a cross-sectional view of an etching apparatus used in an electro-chemical etching process to implement the method according to the first embodiment of the present invention.

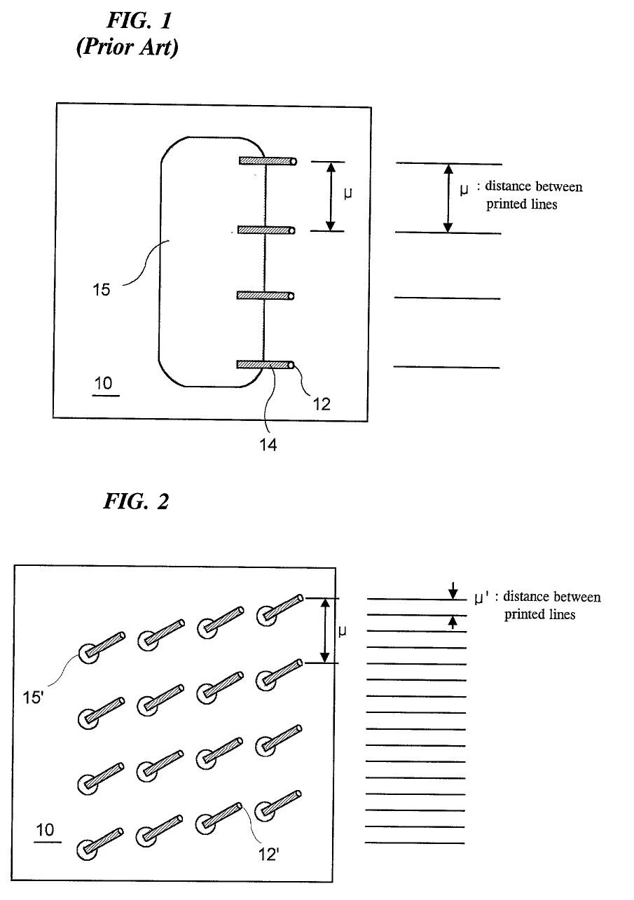

### DESCRIPTION OF THE PREFERRED EMBODIMENT

The preferred embodiments of the present invention will be described hereinafter with reference to the attached drawings.

FIG. 2 is a diagram illustrating the two-dimensional arrangement of ink-supply paths and nozzles in an inkjet printhead according to an embodiment of the present invention. With reference to FIG. 2, ink-supply paths 15′ are formed on the silicon substrate 10 in a two-dimensional array, and nozzles 12′ are formed on the respective ink-supply paths 15′. With this arrangement, it is possible to print lines separated from each other by 10 μm even if the nozzles are separated from each other by 40 μm.

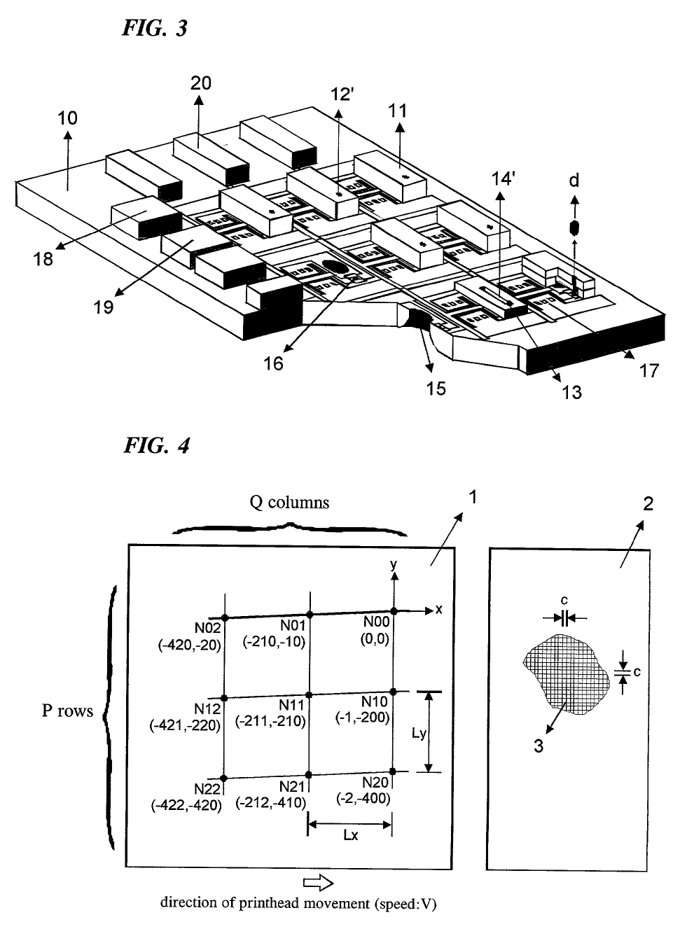

FIG. 3 is a perspective view of an inkjet printhead integrated on a silicon substrate according to an embodiment of the present invention. Part of the silicon substrate is shown as cut off for clear illustration of the present invention. With reference to FIG. 3, the inkjet printhead shown therein is a roof-shooter type printhead. A number of ink-supply paths 15′ are formed on the silicon substrate in a two-dimensional array, and each ink-supply path 15′ is covered with a nozzle plate 11 in which an ink channel 14′, ink chamber 13, and a nozzle 12′ are formed. In order to show the interior structure of the nozzle plate 11 clearly, the nozzle plates 11 are shown as removed or cut off horizontally or partially. Switching devices 17 are arranged near each nozzle 12′ and used to decode the signal applied from outside the printhead and to transmit the decoded signal in the form of electrical energy to the driver of each nozzle in order to selectively drive each nozzle 12′. The electrical energy heats up the heater resistor 16. Ink supplied via the ink-supply paths 15′ expands by this heat so that ink droplets d are ejected via the nozzle 12′. In addition, Vcc and GND pads 18 and 19, switching devices 17, heater resistors 16, and heat pads 20 are formed on the substrate 10.

FIG. 4 is a diagram illustrating the relation between the arrangement of nozzles and printing of the inkjet printhead according to an embodiment of the present invention. With reference to FIG. 4, hypothetical pixels 3 of c×c mm size are formed on the printing paper 2. The resolution is 25.4/c. Nozzles 12′ on the printhead 1 are sequentially selected from the first row to the last row. At the moment when a row is selected, all image data given to all the columns on that row is printed. Nozzles 12′ are located on the printhead 1 with coordinates given by the following formula:

Nij=(−Lₓ·j−T_{row}·V·i, L_{y}·i+c·j) Formula 1

wherein Lₓ is the horizontal distance and L_{y} is the vertical distance between adjacent nozzles, T_{row} is the amount of time during which each row is selected, V is the relative velocity of the printhead 1 with respect to the printing paper 2. For example, if the resolution of the printer is 2400×2400 dpi (dots per inch), then c, Lₓ, L_{y}, and T_{row} can be set as 10 μm, 210 μm, 200 μm, and 3.3 μs, respectively. As shown in FIG. 4, nozzles N00 and N01 are skewed by distance c in the vertical direction in order to print pixels separated from adjacent pixels by distance c in the vertical direction.

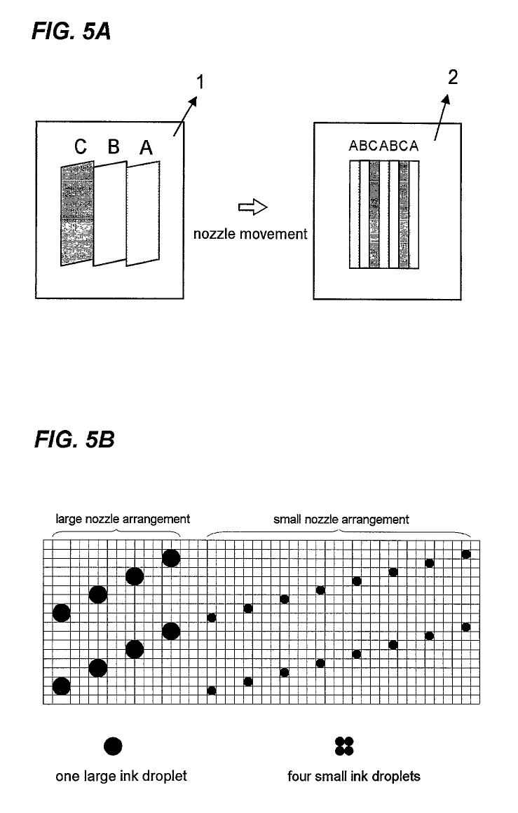

FIGS. 5a and 5b are diagrams illustrating the arrangement of nozzles in order to improve printing speed. As illustrated in FIG. 5a, many two-dimensional nozzle blocks (A, B, and C) are repeatedly arranged and each nozzle block only carries out the printing of a designated area. In this manner, the use of three nozzle blocks results in enhancement of printing speed by threefold. Generally, the use of n nozzle blocks results in enhancing printing speed by n times.

On the other hand, it is also possible to use large nozzles in an area of the printhead along with small nozzles as shown in FIG. 5b. When high-resolution printing is required, only small nozzles are used. When high-speed, low-resolution printing is required, it is possible to selectively drive both the large and small nozzles using electrical signals controlled by a software program to enhance printing speed.

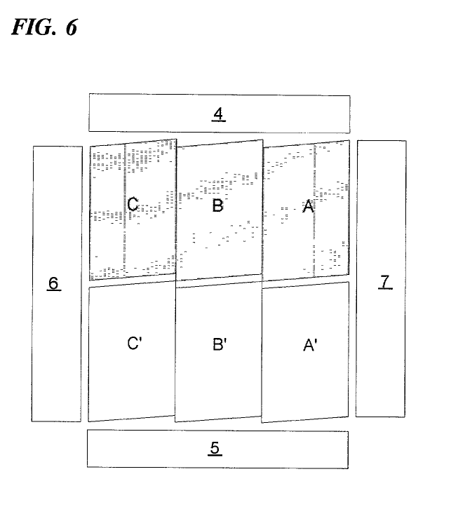

FIG. 6 is a diagram illustrating the arrangement of nozzle blocks and pads according to an embodiment of the present invention. The term “nozzle block” is used to indicate an area of the printhead in which nozzles of the same size are arranged equidistant from adjacent nozzles. As shown in FIG. 6, two-dimensional nozzle blocks (A, B, C and A′, B′, C′) are repeatedly arranged in order to enhance printing speed by use of more nozzles. Column pads 4 and 5 and row pads 6 and 7 are located around the nozzle blocks (A, B, C and A′, B′, C′) to supply electrical energy to the switching devices and heater resistors.

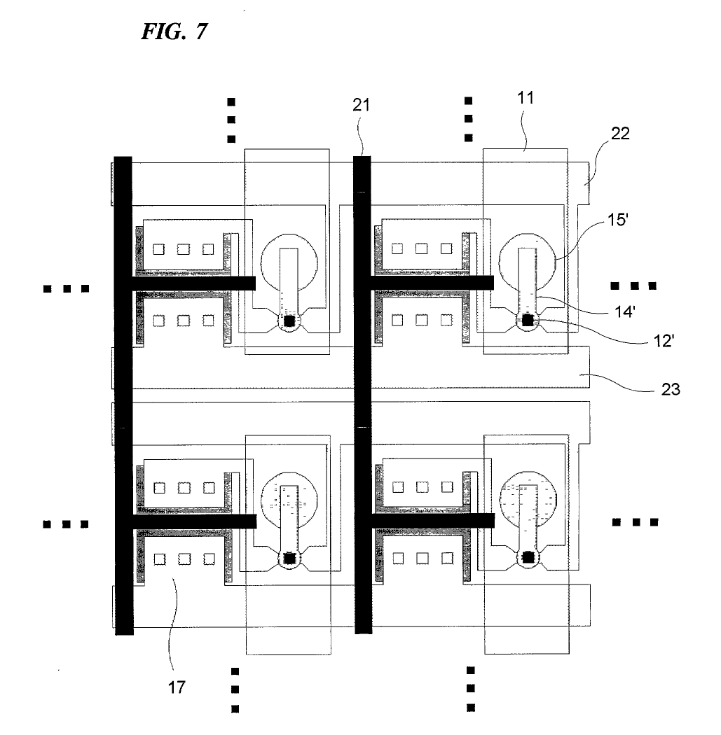

FIG. 7 is a layout diagram of a printhead according to an embodiment of the present invention. FIG. 7 shows nozzles arranged in a 2×2 array and devices and wiring for driving the nozzles. The nozzle plate 11 covers the ink-supply path 15′, and ink channels 14′ and nozzles 12′ are formed in the nozzle plate 11. The nozzle plates 15′ are shown with a see-through view in order to clearly illustrate the elements covered by the nozzle plate 15′. Heater resistors used to eject ink from the nozzles 12′ are not shown in FIG. 7, because it is located under the nozzles 12′. Vcc wiring 22 is connected to the heater resistors in order to supply electrical energy to the heater resistors. Also, switching transistors, comprising polysilicon gate electrodes 21 and gate oxide under the gate electrodes 21, are used to apply electrical signals for driving the heater resistors. FIG. 7 also shows ground (GND) wiring 23.

The method of fabricating an inkjet printhead according to embodiments of the present invention will be illustrated below.

### Fabrication Method According to the First Embodiment

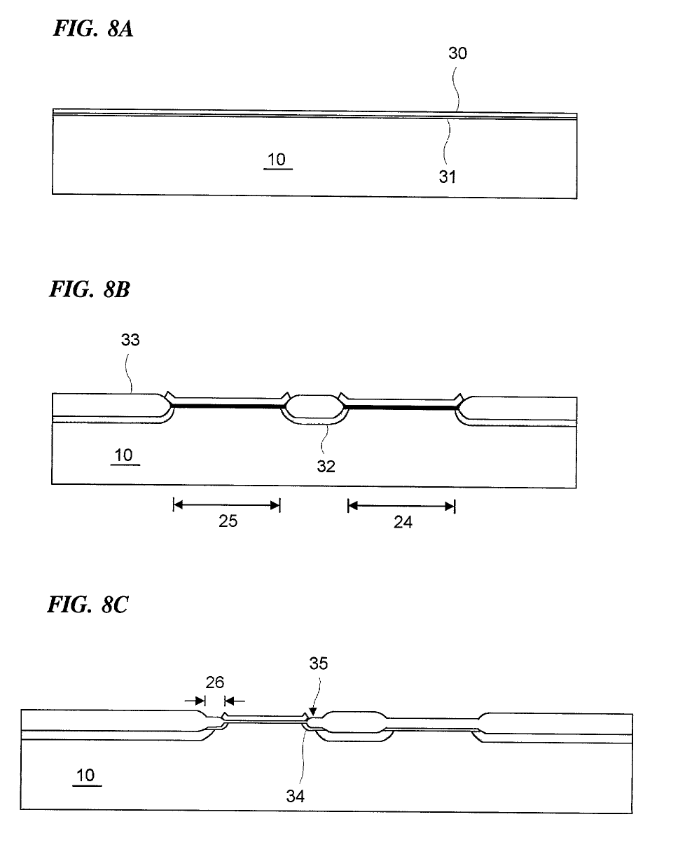

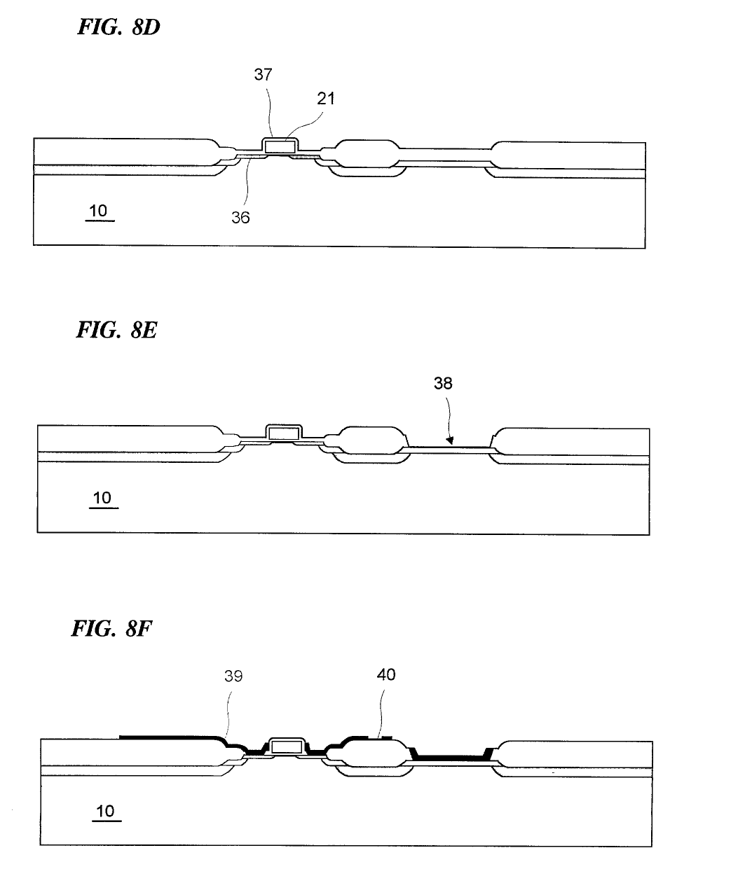

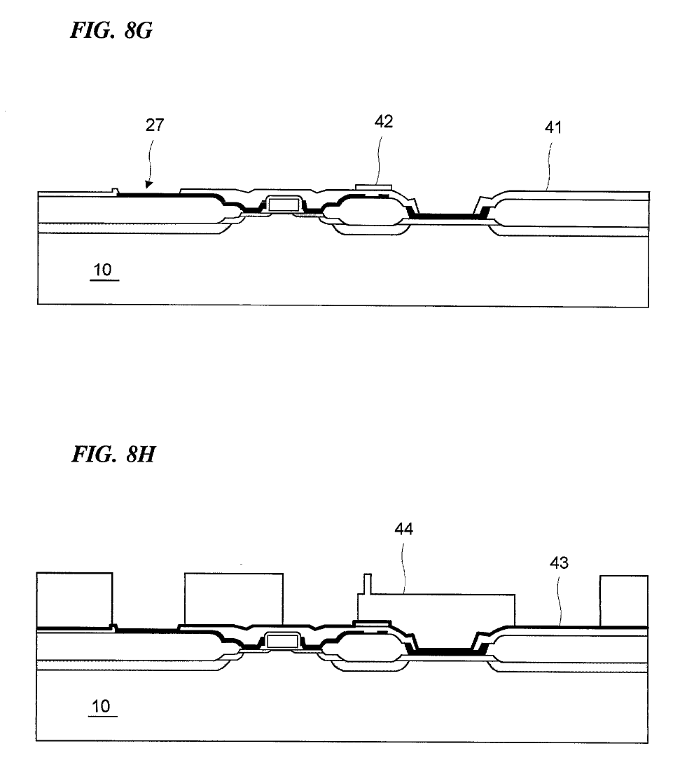

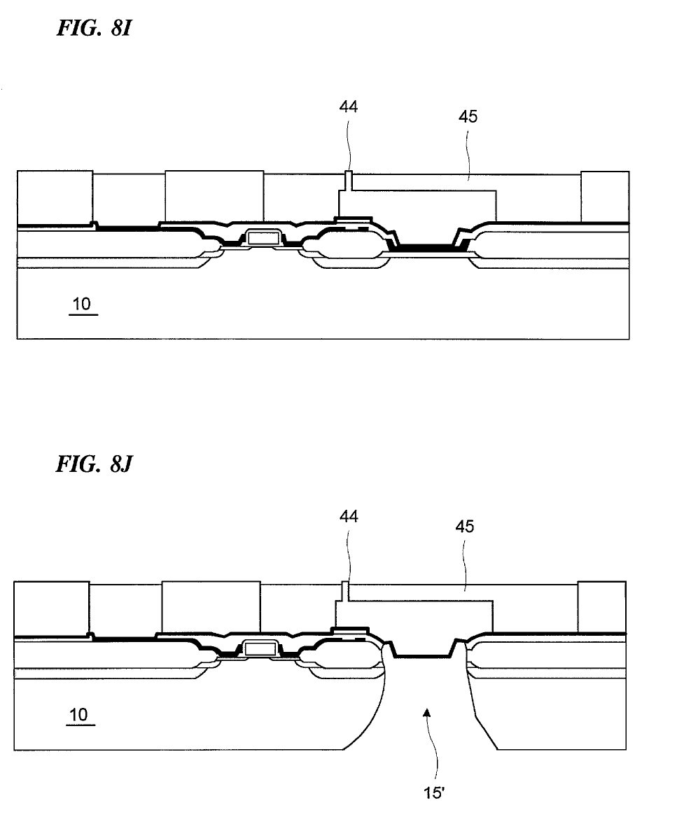

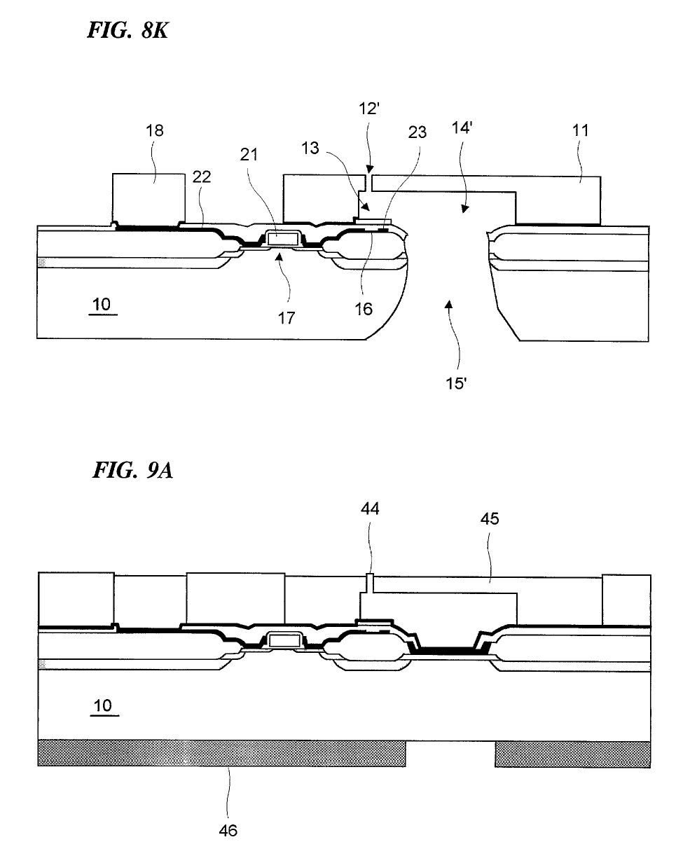

FIGS. 8a through 8k are process cross-sectional views illustrating the method of fabricating an inkjet printhead according to a first embodiment of the present invention.

Referring to FIG. 8a, a silicon oxide layer 31 and a silicon nitride layer 30 are 30 formed on the boron-doped p-type silicon substrate 10 to a thickness of 500 Å and 1500 Å, respectively, for a LOCOS (local oxidation of silicon) process for separation of devices.

Subsequently, as shown in FIG. 8b, in order to prevent over-erosion of the silicon substrate 10 by electrolytic polishing process, the silicon oxide layer 31 and the silicon nitride layer 30 are etched away using the first mask except in the switching device area 25 and the main ink-supply path area 24, and then phosphorous doping is carried out to form a phosphorous-doped layer 32. Subsequently, a thermal oxide layer 33 for prevention of heat transfer during ejection of ink is formed to a thickness of 1.2 μm by wet oxidation in a high-temperature furnace at 1100° C. for 200 minutes.

With reference to FIG. 8c, the oxide layer over the main ink-supply path area 24 and the switching device separation area 26 is removed using the second mask, and the silicon nitride layer over the main ink-supply path area 24 and the switching device separation area 26 is etched away by use of phosphoric acid. Subsequently, boron is doped at 900° C. for 20 minutes to form a boron diffusion area 34 for separation of devices so that, in a subsequent electrolytic polishing process, contact resistance between the electrode and silicon is enhanced and leakage current in transistors is reduced. Then, a heat treatment process in nitrogen environment at 1150° C. for 60 minutes, an oxidation process in vapor environment at 1100° C. for 70 minutes, and a heat treatment process in nitrogen environment at 1100° C. for 20 minutes is carried out sequentially, in order to reduce the boron concentration in the boron diffusion area 34, form a device-separation silicon oxide layer 35, and increase the thickness of the thermal oxide layer 33 for prevention of heat transfer. Thereafter, all the silicon nitride layers are removed using phosphoric acid, and the thin silicon oxide layer under the silicon oxide layer is etched away using BOE (buffered oxide etchant) solution for 1 minute. Additionally, in order to remove the white strip formed during the LOCOS process, a sacrificial oxide layer is formed by an oxidation process in an oxygen environment at 1000° C. for 65 minutes and etching is carried out in BOE solution for 1 minute.

Referring to FIG. 8d, the gate oxide layer of the transistor is formed to a thickness of 300 Å by an oxidation process in oxygen environment at 1000° C. for 20 minutes. Thereafter, a heat treatment process for the gate oxide layer is carried out in nitrogen environment at 1000° C. for 20 minutes in order to improve the electrical characteristics of the gate oxide layer. In order to form the gate electrode of the transistor, a polysilicon layer is deposited to a thickness of 4500 Å and then etched away using the third mask to form the gate 21 of the transistor. The gate oxide over the areas for the source-drain of the transistor is removed, and the source-drain area 36 is formed by doping phosphorous at 970° C. for 30 minutes. In order to compensate for the etching of the side face of the gate oxide layer while etching the gate oxide layer over the source-drain area, an additional oxidation process is carried out in oxygen environment at 1000° C. for 20 minutes. Also, prior to depositing the metal electrode, an oxide layer 37 is deposited to a thickness of 5000 Å for insulation.

Referring to FIG. 8e, the oxide layer over the ink-supply path area is removed using the fourth mask. In addition, boron doping is carried out in this ink-supply path area at 915° C. for 30 minutes to form a boron diffusion layer 38, so that the contact resistance between the ink-supply path area and metal wiring is reduced.

Subsequently, as shown in FIG. 8f, the oxide layer over the source-drain area is removed, and the thin layer for metal wiring and for the heater resistor is deposited and etched using the sixth and seventh mask to form the metal wiring 39 and the heater resistor 40.

Thereafter, as shown in FIG. 8g, in order to protect the transistor, heater resistor, and the wiring from ink, first and second passivation layers 41 and 42 are sequentially deposited. The second passivation layer 42 is etched away using the eighth mask except for the area around the heater resistor. Also, the first passivation layer 41 over the pad-wiring contact window area 27 and the ink-supply path area is etched away using the ninth mask.

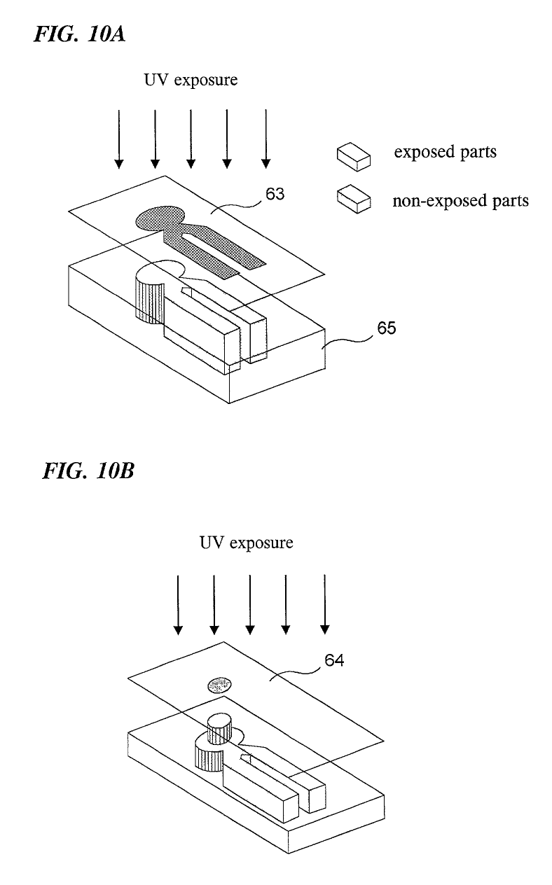

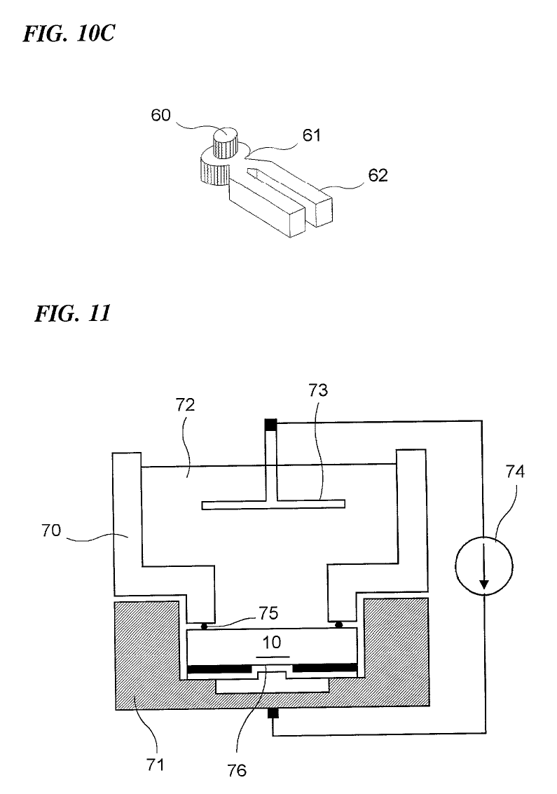

Referring to FIG. 8h, the base metal layer 43 for plating of the nozzle plate is deposited, and the plating mold 44 for plating of the nozzle plate is formed by patterning a photoresistor layer. In this embodiment, the base metal layer 43 is a titanium-gold composite layer (Ti/Au). As shown in FIGS. 10a through 10c, the thick photoresistor layer for the plating mold 44 is exposed to ultraviolet light using sequentially the tenth mask corresponding to the ink channel—ink chamber mask 63 and the eleventh mask corresponding to the nozzle mask 64. At this time, if the exposure period for the tenth mask is long (FIG. 10a) whereas the exposure time for the eleventh mask is short (FIG. 10b), then as shown in FIG. 10c a three-dimensional photoresistor mold comprising a nozzle mold 60, an ink chamber mold 61, and an ink channel mold 62 can be formed by a single photolithography process.

Subsequently, as shown in FIG. 8i, the nozzle plate 45 is formed by a plating process using the plating mold 44. The thickness of plating should be less than that of the photoresistor layer.

With reference to FIG. 8j, the ink-supply path 15′ is formed in the silicon substrate 10 by electro-chemical etching. Electro-chemical etching is carried out in the etching apparatus as shown in FIG. 11. Referring to FIG. 11, the closed space carrying the electro-chemical etching solution 72 is formed by the Teflon bath 70, the bottom surface of the silicon substrate 10, and the O-ring 75. The electrochemical etching solution 72 is typically a mixture of nitric acid, fluoric acid, and water or acetic acid. One end of the direct current device 74 is connected to the platinum electrode 73 inserted in the electro-chemical etching solution 72, and the other end is connected to the copper electrode 71 that is in contact with the silicon substrate 10 and the contact window 76 of the thin metal layer. Thus, the current from the direct current apparatus 74 flows to the silicon substrate 10 via the contact window 76 to form the ink-supply path 15′ of the shape of the contact window 76 in the silicon substrate 10 as shown in FIG. 8j.

Subsequently, as shown in FIG. 8k, boiled acetic acid is used to remove the photoresistor layer covering the ink channel 14′, ink chamber 13, and the nozzle 12′. Finally, the entire process is completed by removing the base metal layer (Ti/Au) using BOE and metal-etching solution.

### Fabrication Method According to the Second Embodiment

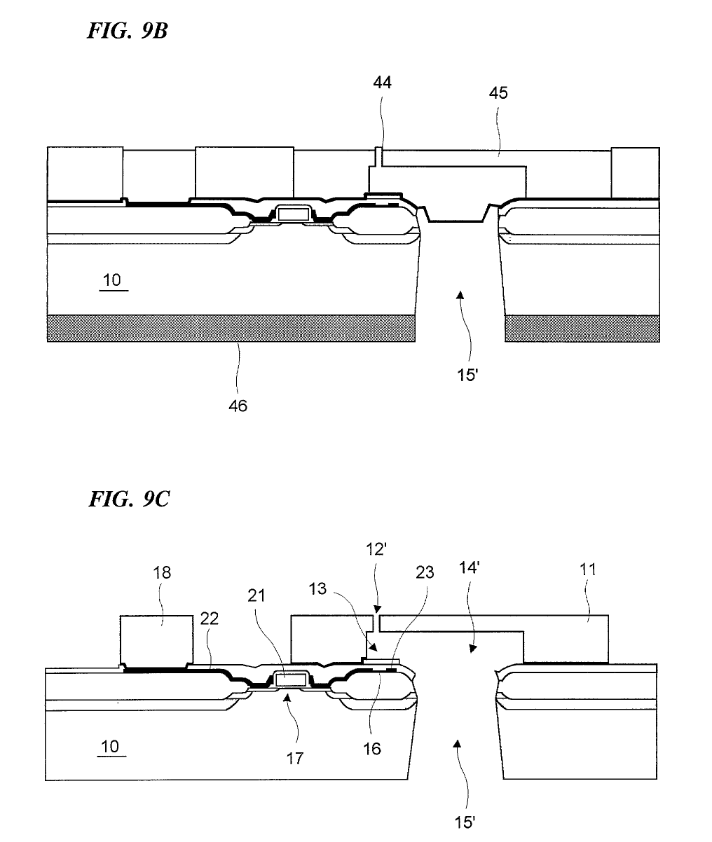

In the method of fabricating an inkjet printhead according to the second embodiment of the present invention, the ink-supply path is formed using a DRIE process. The first half of the process is identical to the process as illustrated in FIGS. 8a through 8h. That is, after completing the plating process of the nozzle, then as shown in FIG. 9a, a photoresistor layer 46 is deposited on the bottom face of the silicon substrate 10. Then, the photoresistor layer in the ink-supply path area is removed using a two-sided aligned exposure apparatus.

Subsequently, as shown in FIG. 9b, the silicon substrate 10 is etched from the bottom surface thereof using a DRIE process. At this time, the base metal 43 for plating or the photoresistor layer 44 used as the plating mold functions as the etch stop layer.

Thereafter, as shown in FIG. 9c, boiled acetic acid is used to remove the photoresistor layer 46 used in the DRIE process and the photoresistor layer 44 covering the ink channel 14′, ink chamber 13, and the nozzle 12′. Finally, the entire process is completed by removing the base metal layer 43 (Ti/Au) for plating using BOE and metal-etching solution.

In order to achieve high-resolution printing at the same level as photographs as demanded by customers, an inkjet printhead that is capable of high-resolution printing at the level of 2400-3600 dpi is required. However, conventional methods of fabricating inkjet printheads merely produced printheads of 600 dpi resolution considering the nozzle size and the nozzle arrangement pitch. The method of the present invention is capable of realizing an inkjet printhead of 2400×2400 dpi resolution. In addition, the printing speed is not deteriorated at all in the inkjet printhead of 2400×2400 dpi resolution according to the present invention. Therefore, use of inkjet printhead of the present invention can result in prints of the same resolution as in photographs, and the market for such inkjet printhead will be enormous.

Although the present invention has been illustrated with reference to embodiments of the present invention, various modifications are possible within the scope of the present invention. Therefore, the scope of the present invention should be defined not by the illustrated embodiments but by the attached claims.

What is claimed is:

1. An inkjet printhead comprising:
a substrate having at least four ink-supply path orifices, arranged in a two-dimensional array, for supplying a single color ink;
at least one nozzle connected to each of the ink-supply path orifices;
driving means for driving the nozzles; and
electrical devices for decoding electric signals provided from outside the inkjet printhead and transmitting the decoded electric signals to the driving means in order to selectively drive the nozzles.

2. The inkjet printhead as claimed in claim 1, wherein the two-dimensional array of the ink-supply path orifices is a n×n array or a 1×n array, wherein n is a natural number greater than 2.

3. The inkjet printhead as claimed in claim 1, wherein the size of the nozzles are different in each area of the two-dimensional array, thereby implementing a variety of resolutions and enhancing printing speed.

4. The inkjet printhead as claimed in claim 1, wherein each ink-supply path comprises at least one nozzle and an ink channel corresponding to each nozzle.

5. The inkjet printhead as claimed in claim 1, wherein the driving means ejects ink from the nozzles by heat ejection or piezoelectric ejection.

6. The inkjet printhead as claimed in claim 1, wherein the electrical device is a switching device such as a diode or a metal-oxide-silicon (MOS) transistor and is integrated on the substrate.

7. The inkjet printhead as claimed in claim 1, wherein each nozzle is formed in a nozzle plate covering the ink-supply path orifices, the nozzle plate comprising a conductive layer that can function as a power supply line or a ground line for driving the inkjet printhead.

8. The inkjet printhead as claimed in claim 1, wherein the two-dimensional array of ink-supply path orifices and nozzles comprises rows forming a certain angle with respect to a print-movement direction of the inkjet printhead.

9. The inkjet printhead as claimed in claim 1, wherein the nozzles are arranged in array blocks, and different color ink is supplied to each array block to enable printing of a plurality of colors.

10. A method of fabricating an inkjet printhead, the method comprising the steps of:
sequentially forming a silicon oxide layer and a silicon nitride layer on a silicon substrate doped with a first conductive-type impurity;
etching the silicon oxide layer and the silicon nitride layer except in a switching device area and a main ink-supply path area to expose parts of the substrate, and doping the exposed parts with a second conductive-type impurity;
oxidizing the exposed parts to form a heat-transfer-prevention silicon oxide layer on the exposed parts of the substrate;
removing the silicon oxide layer and the silicon nitride layer over the entire main ink-supply path area and over both ends of the switching device area, and doping the entire main ink-supply path area and both ends of the switching device area with the first conductive-type impurity to form a device-separation first conductive-type impurity diffusion layer;
sequentially carrying out oxidizing and heat treating processes in order to reduce the doping concentration of the device-separation first conductive-type impurity diffusion layer and form a device-separation silicon oxide layer at two ends of the switching device area as well as make the heat-transfer-prevention silicon oxide layer thicker;
removing all the silicon nitride layer that is remaining and the silicon oxide layer under the silicon nitride layer;
forming on the switching device area a switching transistor including a gate oxide layer, a polysilicon gate electrode layer, and a source-drain area;
removing the oxide layer over the main ink-supply path area and carrying out a doping process with the first conductive-type impurity in order to reduce a contact resistance between the main ink-supply path area and a metal wiring to be formed subsequently;
removing the oxide layer over the source-drain area and depositing and etching the metal wiring and a heater resistor thin film to form wiring and the heater resistor;
sequentially depositing a first and a second passivation layer for protection of the transistor, heater resistor, and the wiring from ink, etching the second passivation layer except in an area near the heater resistor, and etching the first passivation layer over a pad-wiring contact window area and the main ink-supply path area;
depositing a base metal layer for plating of a nozzle plate, and forming a plating mold including an ink channel mold, an ink chamber mold, and a nozzle mold by photoresistor layer patterning for plating of the nozzle plate;
forming the nozzle plate by plating using the plating mold, the thickness of plating being less than the height of the photoresistor layer;
etching the substrate to form the main ink-supply path; and
removing the plating mold and subsequently removing the base metal layer.

11. The method of fabricating an inkjet printhead as claimed in claim 10, wherein the first conductive-type is p-type and the second conductive-type is n-type.

12. The method of fabricating an inkjet printhead as claimed in claim 10, wherein the step of forming the plating mold comprises forming the three-dimensional nozzle mold by a single photolithography process including depositing the photoresistor layer once followed by double-exposing using an ink chamber/ink channel mask and a nozzle mask with different exposure time for each mask.

13. The method of fabricating an inkjet printhead as claimed in claim 10, wherein the step of etching the substrate to form the main ink-supply path comprises an electrolytic polishing process.

14. The method of fabricating an inkjet printhead as claimed in claim 10, wherein the step of etching the substrate to form the main ink-supply path comprises the steps of:
depositing a photoresistor layer on the bottom face of the silicon substrate and removing the photoresistor layer in the main ink-supply path area using a two-sided aligned exposure apparatus; and
etching the silicon substrate from the bottom face of the silicon substrate using deep reactive ion etching process.

15. The method of fabricating an inkjet printhead as claimed in claim 14, wherein the base metal layer or the photoresistor layer used for the plating mold is used as an etch stop layer in the deep reactive ion etching process.

16. An inkjet printhead having a two-dimensional nozzle array capable of high-speed, high-resolution printing, the inkjet printhead comprising:
a substrate having at least one ink-supply path for supplying a single color ink;
at least two nozzles positioned in a line parallel to the movement direction of the printhead, each nozzle being connected to the ink-supply path;
driving means for driving the nozzles; and
electrical devices for decoding electric signals provided from outside the inkjet printhead and transmitting the decoded electric signals to the driving means in order to selectively drive the nozzles.

17. The inkjet printhead as claimed in claim 16, wherein the two-dimensional nozzle array is a n×n array or a 1×n array, wherein n is a natural number greater than 2.

18. The inkjet printhead as claimed in claim 16, wherein the size of the nozzles are different in each area of the two-dimensional nozzle array, thereby implementing a variety of resolutions and enhancing printing speed.

19. The inkjet printhead as claimed in claim 16, wherein the driving means ejects ink from the nozzles by heat ejection or piezoelectric ejection.

20. The inkjet printhead as claimed in claim 16, wherein the electrical device is a switching device such as a diode or a metal-oxide-silicon (MOS) transistor and is integrated on the substrate.

21. The inkjet printhead as claimed in claim 16, wherein the nozzles are arranged in array blocks, and different color ink is supplied to each array block to enable printing of a plurality of colors.
